(19) United States
(12) Patent Application Publication
(10) Pub. No.: US 2006/0023149 A1
(43) Pub. Date: Feb. 2, 2006

(54) Continuous domain vertical alignment liquid crystal display

(75) Inventors: Tze-Min Lin, Miao-Li (TW); Chueh-Ju Chen, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/175,073

(22) Filed: Jul. 5, 2005

(30) Foreign Application Priority Data
Jul. 30, 2004 (TW) 93122893

(51) Int. Cl. G02F 1/1337

(52) U.S. Cl. 349/129

(57) ABSTRACT

A continuous domain vertical alignment LCD (4) includes a first substrate (41) and a second substrate (42), liquid crystal molecules (46) interposed therebetween, and a plurality of curved first and second protrusions (411, 421) disposed at insides of the first and second substrate respectively. Each of the first and second protrusions respectively includes a first curve portion (481, 491) having a first substantially rectilinear part (483, 493), and a second curve portion (482, 492) having a second substantially rectilinear part (484, 494). The first curvature parts (481, 491) connect to the second infinite curvature parts (483, 493). The LCD provides a more even display performance at various different viewing angles.

### FIELD OF THE INVENTION

The present invention relates to vertical alignment liquid crystal displays (LCDs), and particularly to a vertical alignment LCD having continuous domains.

### BACKGROUND

Since LCDs are thin and light, consume relatively little electrical power, and do not cause flickering, they have helped spawn product markets such as for laptop personal computers. In recent years, there has also been great demand for LCDs to be used as computer monitors and even televisions, both of which are larger than the LCDs of laptop personal computers. Such large-sized LCDs in particular require that an even brightness and contrast ratio prevail over the entire display surface, regardless of observation angle.

Because the conventional TN (twisted nematic) mode LCD cannot easily satisfy these demands, a variety of improved LCDs have recently been developed. They include IPS (in-plane switching) mode LCDs, optical compensation TN mode LCDs, and MVA (multi-domain vertical alignment) mode LCDs. In MVA mode LCDs, each pixel is divided into multiple domains. Liquid crystal molecules of the pixel are vertically aligned when no voltage in applied, and are inclined in different directions according the domains they are in when a voltage is applied. In other words, in each pixel, the effective direction of the electric field in one domain is different from the effective direction of the electric field in a neighboring domain. Typical MVA mode LCDs have four domains in a pixel, and use protrusions and/or slits to form the domains.

FIG. 7 shows one kind of MVA LCD. The MVA LCD 1 includes liquid crystal molecules 16 oriented in four domains A, B, C, D. Protrusions 111, 121 are arranged on inner surfaces of two substrates (not shown) respectively, along generally V-shaped paths. Liquid crystal molecules 16 at two opposite sides of the upper portions of the protrusions 111, 121 incline in directions C and D, while liquid crystal molecules 16 at two opposite sides of the lower portions of the protrusions 111, 121 incline in directions A and B. The orientation direction of the liquid crystal molecules 16 in each same inter-protrusion region (e.g., direction A in region A) is orthogonal to the orientation directions of the liquid crystal molecules 16 in all of the other inter-protrusion regions (e.g., directions B, C, D in regions B, C, D). Therefore, each pixel attains a visual effect that is an overall result of four domains. This gives the MVA LCD 1 a more even display performance at various different viewing angles.

However, the four-domain configuration can only compensate visual performance in four directions. The overall viewing angle characteristics of the MVA LCD 1 are still inherently limited, and the MVA LCD 1 cannot satisfactorily present a uniform display at all viewing angles.

FIG. 8 shows a continuous domain vertical alignment LCD which overcomes the above-described problem. The continuous domain vertical alignment LCD 2 includes protrusions 211, 221 respectively disposed on inner surfaces of two substrates (not shown). The LCD 2 also includes a first polarizer (not shown) and a second polarizer (not shown). The second polarizer has a polarizing axis perpendicular to that of the first polarizer. Each of the protrusions has an arcuate shape. When the LCD 2 is in an on state, a voltage is applied thereto, and the common and pixel electrodes (not shown) generate an electric field perpendicular to the substrates. The liquid crystal molecules 26 have negative dielectric anisotropy, and are therefore inclined to be oriented parallel to the substrates. In addition, the protrusions 211, 221 affect the orientations of the liquid crystal molecules 26, such that the liquid crystal molecules 26 form continuums of inclined alignments perpendicular to the slopes of the protrusions 211, 221. The visual effect of the LCD 2 is the sum of multiple smoothly continuous domains. Thus the LCD 2 provides a more even display performance at various different viewing angles compared to the MVA LCD 1.

The protrusions 211, 221 have an arcuate shape, and the center portions thereof according to a region 28 have a larger curvature. Therefore, when a voltage is applied to the electrodes and protrusions 211, 221, the liquid crystal molecules 26 in the region 28 are oriented essentially only in two directions. This means that in the region 28, projections of the liquid crystal molecules 26 on the substrates are aligned parallel to the polarizing axis of the polarizer of the LCD 2. That is, projections of the long axes of the liquid crystal molecules 26 on the substrates are parallel to the polarizing axis of the polarizer. In operation, ambient incident light becomes linearly-polarized light after passing through the first polarizer. The polarizing direction of the linearly-polarized light passing through the region 28 does not change, because of transmission along the long axes of the liquid crystal molecules 26. Accordingly, the light passing through the region 28 cannot pass though the second polarizer that has a polarizing axis perpendicular to that of the first polarizer. As a result, the region 28 is liable to form a dark area when the LCD 2 is used to display images.

What is needed, therefore, is a continuous domain vertical alignment LCD which can provide a uniform display at all viewing angles without any dark areas.

### SUMMARY

In a preferred embodiment, a continuous domain vertical alignment LCD includes a first substrate and a second substrate, liquid crystal molecules interposed therebetween, and a plurality of curved first and second protrusions disposed at insides of the first and second substrate respectively. Each of the first and second protrusions respectively defines a first curve portion having a first substantially rectilinear first part, and a second curve portion having a second substantially rectilinear second part. The first part connects to the corresponding second part.

The projections of the liquid crystal molecules affected by the parts projected to the second substrates are not parallel to the polarizing axis of the polarizer of the second substrates. Therefore, the LCD avoid yielding a dark area similar to that of the conventional LCD. Thus, the LCD provides a more even display performance at various different viewing angles compared to the conventional LCD.

Other advantages and novel features will become more apparent from the following detailed description when taken in conjunction with the accompanying drawings.

### BRIEF DESCRIPTION OF THE DRAWINGS

FIG. 1 is a schematic, isometric view of part of a continuous domain vertical alignment LCD according to a first embodiment of the present invention, showing the LCD in an on state.

FIG. 2 is a schematic, top elevation of part of the LCD according to the first embodiment of the present invention in the on state, but not showing a first substrate or a main body of a common electrode thereof, and showing orientations of liquid crystal molecules thereof.

FIG. 3 is similar to FIG. 1, but showing the LCD in an off state.

FIG. 4 is a schematic, top elevation of part of an LCD according to a second embodiment of the present invention in an on state, not showing a first substrate or a main body of a common electrode of the LCD, and thereby showing orientations of liquid crystal molecules of the LCD.

FIG. 5 is a schematic, isometric view of part of a continuous domain vertical alignment LCD according to a third embodiment of the present invention, showing the LCD in an on state.

FIG. 6 is a schematic, isometric view of part of a continuous domain vertical alignment LCD according to a fourth embodiment of the present invention, showing the LCD in an on state.

FIG. 7 is a schematic, top elevation of part of a conventional MVA LCD in an on state, not showing a first substrate or a main body of a common electrode of the LCD, and thereby showing orientations of liquid crystal molecules of the LCD.

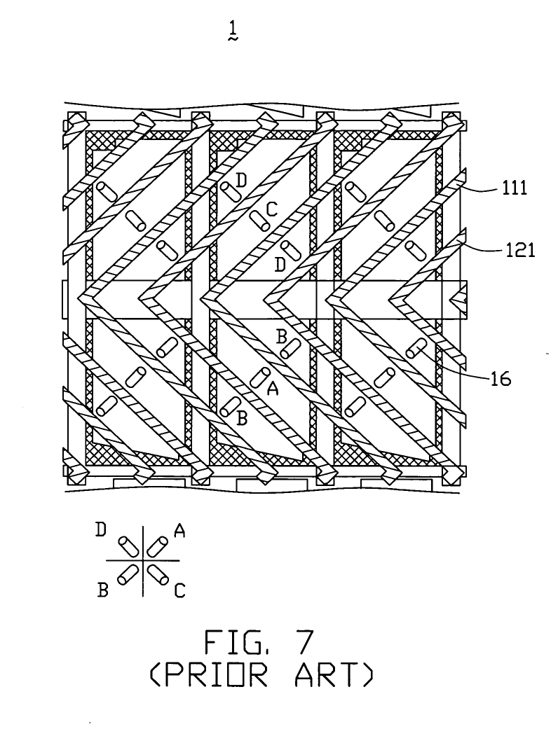

FIG. 8 is a schematic, top elevation of part of a conventional continuous domain vertical alignment LCD in an on state, not showing a first substrate or a main body of a common electrode of the LCD, and thereby showing orientations of liquid crystal molecules of the LCD.

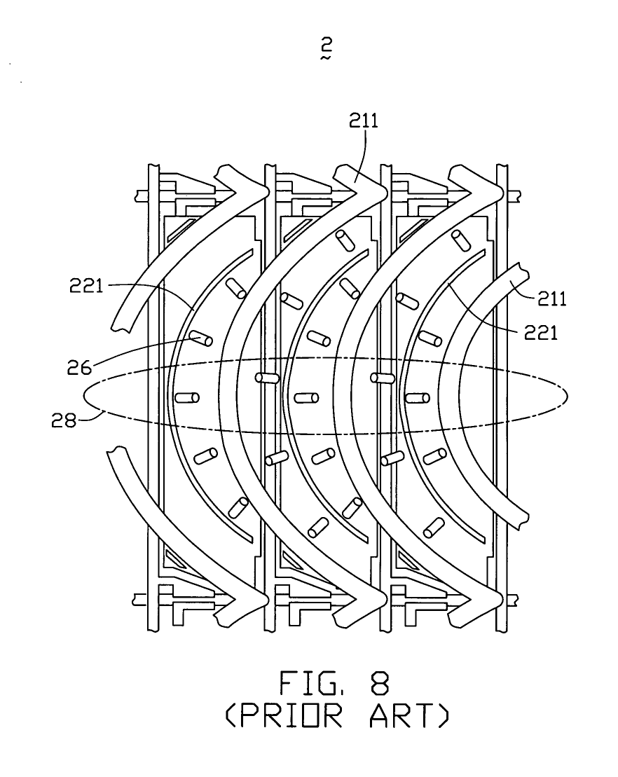

### DETAILED DESCRIPTION OF PREFERRED EMBODIMENTS

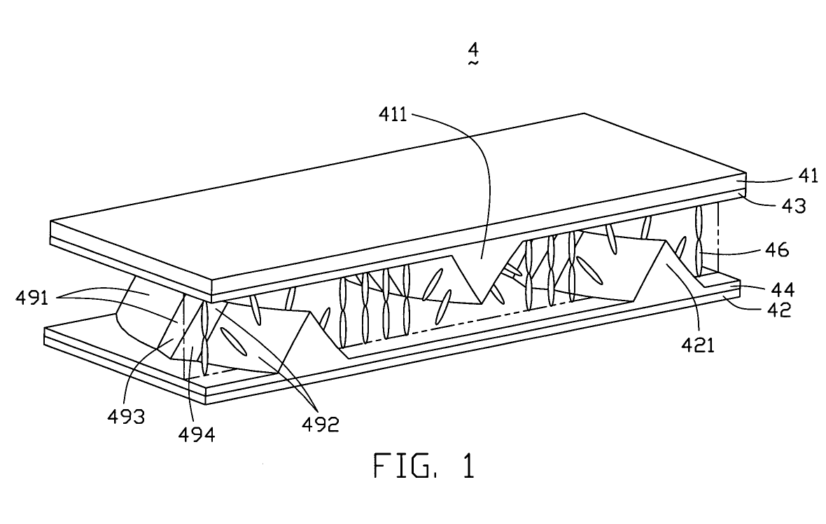

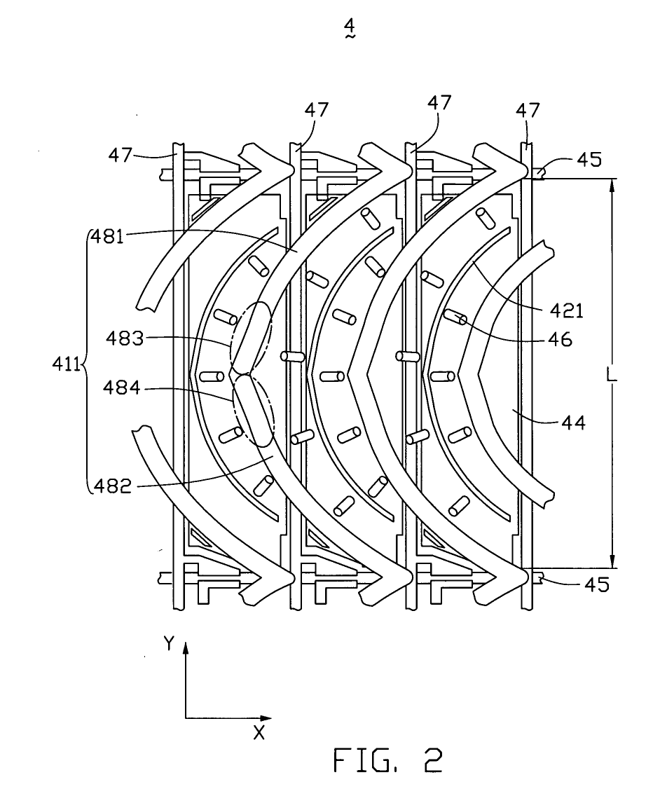

Referring to FIGS. 1-2, part of a continuous domain vertical alignment LCD 4 according to the first embodiment of the present invention is shown. The LCD 4 includes a first substrate 41, a second substrate 42, liquid crystal molecules 46 interposed between the first and second substrates 41, 42, and a plurality of gate lines 45 and date lines 47 formed on the second substrate 42. The LCD 4 also includes a first polarizer (not shown) and a second polarizer (not shown). The second polarizer is provided at the second substrate 42, and has a polarizing axis perpendicular to that of the first polarizer. A common electrode 43 is formed on the first substrate 21, and a plurality of pixel electrodes 44 is formed on the second substrate 42. A plurality of the first protrusions 411 is formed on the common electrode 43, and a plurality of second protrusions 421 is formed on the pixel electrodes 44.

Each of the first protrusions 411 and the second protrusions 421 has a mainly arcuate shape, and a triangular cross-section. Each of the first protrusions 411 includes a first curve portion 481 and a second curve portion 482. The first curve portion 481 has a part 483, which is substantially rectilinear. The second curve portion 482 has a part 484, which is substantially rectilinear. The part 483 connects to the part 484. The second protrusions 421 have a shape similar to that of the first protrusions 411. That is, each of the second protrusions 421 includes a first curve portion 491 and a second curve portion 492. The first curve portion 491 has a part 493, which is substantially rectilinear. The second curve portion 492 has a part 494, which is substantially rectilinear. The part 483 connects to the part 484.

Typically, maximum widths of the first protrusions 411 are larger than maximum widths of the second protrusions 421. In the illustrated embodiment, the maximum width of the first protrusions 411 is about 10 microns, and the maximum width of the second protrusions 421 is about 7.5 microns.

When no voltage is applied to the LCD 4, most of the liquid crystal molecules 46 between the first substrate 41 and the second substrate 42 are aligned in vertical directions. Therefore light beams passing between the first and second substrates 41, 42 do not change their polarization states.

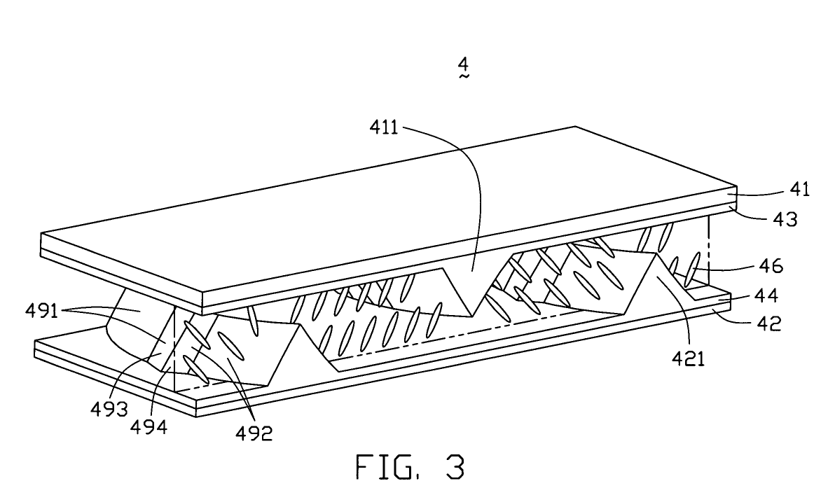

Also referring to FIG. 3, when the LCD 4 is in an on state, a voltage is applied thereto. The common electrode 43 and the pixel electrodes 44 generate an electric field perpendicular to the first substrate 41 and the second substrate 42. The liquid molecules 46 have negative dielectric anisotropy, and are therefore inclined to be oriented parallel the first substrate 41. In addition, the protrusions 411, 421 affect the orientations of the liquid crystal molecules 46, such that the liquid crystal molecules 46 form continuums of inclined alignments perpendicular to the slopes of the protrusions 422, 421.

The visual effect of the LCD 4 is the sum of multiple smoothly continuous domains, except in the regions between the connecting parts 483, 484 of the first protrusions 411 and the connecting parts 493, 494 of the second protrusions 421. This is because all the parts 483, 484, 493, 494 are substantially rectilinear. In said regions, the orientations of the liquid crystal molecules 46 are affected by the parts 483, 484, 493, 494, and therefore projections of the liquid crystal molecules 46 on the substrates 41, 42 are not parallel to the polarizing axis of the second polarizer of the second substrate 42. Therefore the LCD 4 avoids yielding a dark display area corresponding to said regions, unlike in the case of the conventional LCD 2. Thus, the LCD 4 provides a more even display performance at various different viewing angles compared to the conventional LCD 2.

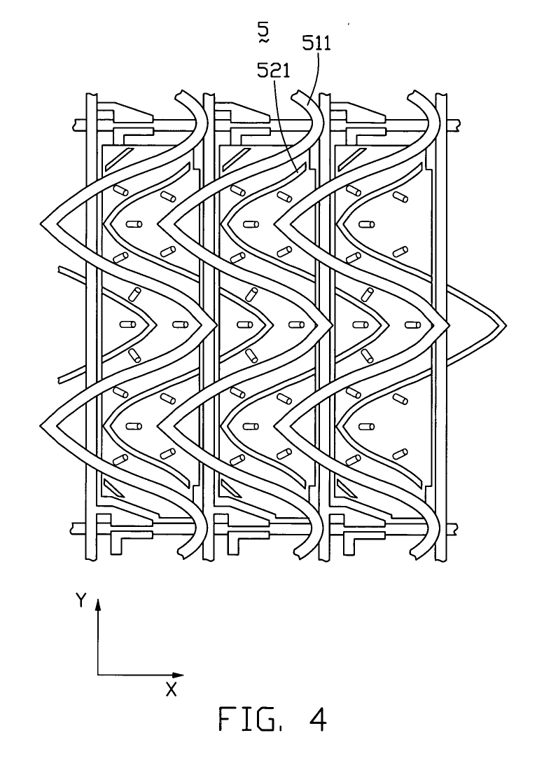

FIG. 4 is a view of a continuous domain vertical alignment LCD 5 according to the second embodiment of the present invention, showing the LCD 5 in an on state. The continuous domain vertical alignment LCD 5 has a structure similar to that of the LCD 4. In the illustrated embodiment, first and second protrusions 511, 521 are mainly “S” shaped. The first and second protrusions 511, 521 have a plurality of substantially rectilinear parts. The LCD 5 also can provide an even display performance at various different viewing angles.

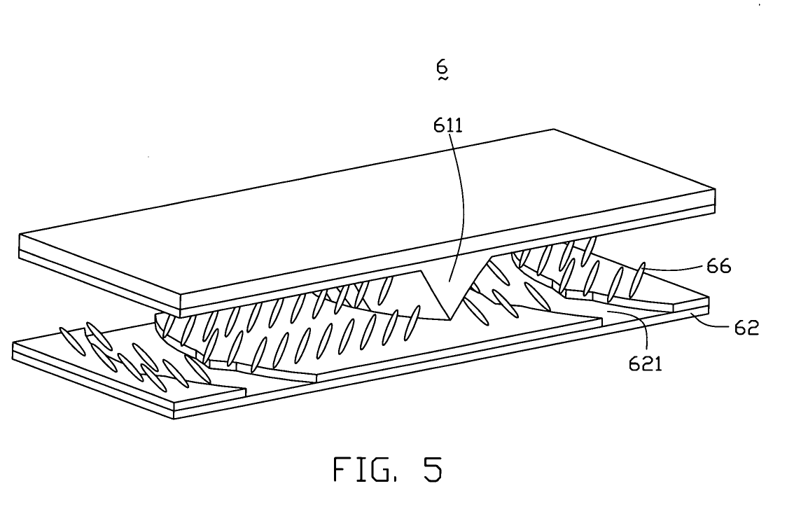

FIG. 5 is a view of a continuous domain vertical alignment LCD 6 according to the third embodiment of the present invention, showing the LCD 6 in an on state. The LCD 6 has a structure similar to that of the LCD 4. However, the LCD 6 has a plurality of slits 621 disposed at an inner surface of the second substrate 62, for cooperating with protrusions 611 to affect orientations of liquid crystal molecules 66. Both the protrusions 611 and the slits 621 include a plurality of substantially rectilinear parts. The LCD 6 also can provide an even display performance at various different viewing angles.

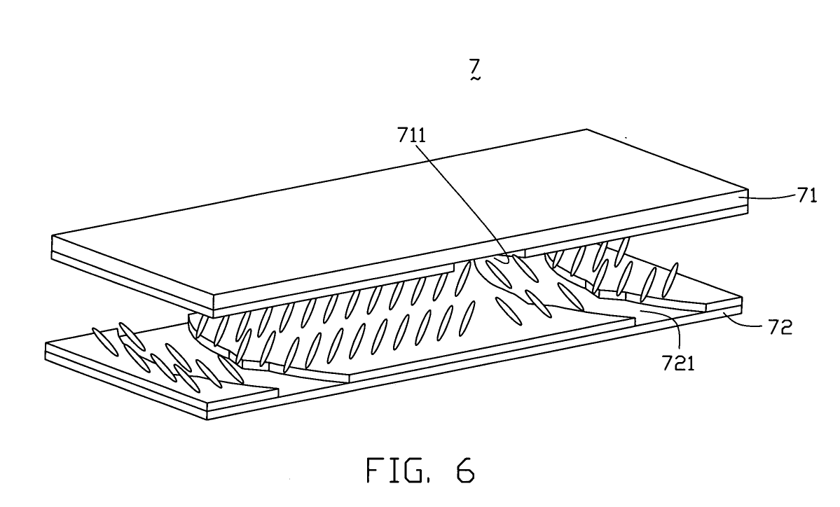

FIG. 6 is a view of a continuous domain vertical alignment LCD 7 according to the fourth embodiment of the present invention, showing the LCD 7 in an on state. The LCD 7 has a structure similar to that of the LCD 4. However, the LCD 7 has a plurality of slits 711, 721 disposed at inner surfaces of the first and second substrates 71, 72, respectively, in order to affect orientations of the liquid crystal molecules 76. The slits 711, 721 include a plurality of substantially rectilinear parts. The LCD 7 also can provide an even display performance at various different viewing angles.

It is to be understood, however, that even though numerous characteristics and advantages of preferred embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the

What is claimed is:

1. A continuous domain vertical alignment liquid crystal display, comprising:
a first substrate and a second substrate, and liquid crystal molecules interposed therebetween; and
a plurality of curved first protrusions and a plurality of curved second protrusions disposed at insides of the first substrate and the second substrate respectively;
wherein each of the first protrusions defines a first curve portion having a substantially rectilinear first part, and a second curved portion having a substantially rectilinear second part, the first part being connected to the second part; and each of the second protrusions defines a first curve portion having a substantially rectilinear first part, and a second curve portion having a substantially rectilinear second part, the first part being connected to the second part.

2. The continuous domain vertical alignment liquid crystal display of claim 1, wherein each of the first and second protrusions has a triangular cross-section.

3. The continuous domain vertical alignment liquid crystal display of claim 2, wherein a maximum width of each first protrusion is greater than a maximum width of each second protrusion.

4. The continuous domain vertical alignment liquid crystal display of claim 3, wherein the maximum width of each first protrusion is 10 microns, and the maximum width of each second protrusion is 7.5 microns.

5. The continuous domain vertical alignment liquid crystal display of claim 1, wherein the first and second protrusions are generally “S” shaped.

6. A continuous domain vertical alignment liquid crystal display, comprising:
a first substrate and a second substrate, and liquid crystal molecules interposed therebetween; and
a plurality of first alignment-controlling members and a plurality of second alignment-controlling members, disposed at insides of the first substrate and the second substrate respectively;
wherein the first alignment-controlling members and the second alignment-controlling members each define substantially parts, and cooperate to assist the formation of a continuum of multiple domains of orientation of the liquid crystal molecules when the continuous domain vertical alignment liquid crystal display is in an on state.

7. The continuous domain vertical alignment liquid crystal display of claim 6, wherein the first alignment-controlling members and the second alignment-controlling members are first and second protrusions respectively.

8. The continuous domain vertical alignment liquid crystal display of claim 7, wherein the protrusions are mainly curved.

9. The continuous domain vertical alignment liquid crystal display of claim 8, wherein each of the first protrusions defines a first curve portion having a substantially rectilinear first part, and a second curve portion having a substantially rectilinear second part, the first part being connected to the second part; and each of the second protrusions defines a first curve portion having a substantially rectilinear first part, and a second curve portion having a substantially rectilinear second part, the first part being connected to the second part.

10. The continuous domain vertical alignment liquid crystal display of claim 9, wherein each of the first and second protrusions has a triangular cross-section.

11. The continuous domain vertical alignment liquid crystal display of claim 10, wherein a maximum width of each first protrusion is greater than a maximum width of each second protrusion.

12. The continuous domain vertical alignment liquid crystal display of claim 11, wherein the maximum width of each first protrusion is 10 microns, and the maximum width of each second protrusion is 7.5 microns.

13. The continuous domain vertical alignment liquid crystal display of claim 7, wherein the first and second protrusions are generally “S” shaped.

14. The continuous domain vertical alignment liquid crystal display of claim 6, wherein the first alignment-controlling members are protrusions and the second alignment-controlling members are slits respectively.

15. The continuous domain vertical alignment liquid crystal display of claim 6, wherein the first and second alignment-controlling members are slits.

16. A continuous domain vertical alignment liquid crystal display, comprising:
a first substrate and a second substrate, and liquid crystal molecules interposed therebetween; and
a plurality of first protrusions upwardly extending above the first substrate and toward the second substrate from a side view, and arranged in a serpentine manner from a top view;
wherein each of the protrusions defines two oblique upward surfaces converging with each other at top edges, and a projection is formed at each reversely bending point of the oblique upward surface; wherein
the protrusion essentially extends perpendicular to the first substrate, and the projection essentially extends perpendicular to the corresponding oblique upward surface while oblique to the first substrate.
